(19) United States
(12) Patent Application Publication
(10) Pub. No.: US 2008/0152818 A1
(43) Pub. Date: Jun. 26, 2008

(54) NON-AQUEOUS COATING COMPOSITIONS

(75) Inventor: Pillai T. Perumal, Avon Lake, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 11/950,898

(22) Filed: Dec. 5, 2007

Related U.S. Application Data
(60) Provisional application No. 60/869,031, filed on Dec. 7, 2006.

(51) Int. Cl. C08L 27/00; B32B 27/08; B05D 3/10; B65D 83/14; B05B 11/00

(52) U.S. Cl. 427/393.5; 524/551; 428/500; 427/385.5; 239/337; 222/402.13

(57) ABSTRACT

Non-aqueous graft polymers and coatings, including aerosol coatings, are described. The graft copolymers are useful for application to plastic and other substrates.

This application claims the benefit of U.S. provisional patent application No. 60/869,031 filed on Dec. 7, 2006, the entirety of which is hereby incorporated by reference.

Plastics, such as thermoplastic polyolefins (TPO) and reaction injected molding urethane (RIM), are frequently utilized as parts in the automotive industry and in other applications because of their relatively low cost, moldability, and superior resistance to solvents and moisture.

The plastics are, however, frequently difficult to paint due to one or more of their physical and chemical characteristics, such as their relatively non-polar surface (especially for polyolefins like polypropylene, polyethylene, ethylene propylene diene copolymer, etc.) and the surface tension, roughness and flexibility of the cured plastic itself. Sometimes the plastic substrates are treated with a flame, corona or gas plasma treatment, or coated with a tie coat or adhesion promoter but this adds an additional manufacturing step. Some tie coats and adhesion promoters utilize halogenated, especially chlorinated, polyolefins, but the halogenated polyolefins are relatively expensive and are costly if used in large amounts. Additionally, the halogenated polyolefins are often relatively high molecular weight polymers, and they often are relatively insoluble in many non-aromatic solvents. These characteristics can make it difficult to minimize VOC (Volatile Organic Content) when incorporating halogenated polyolyfins.

The present invention relates to coating compositions which can be applied to a variety of substrates, including plastic substrates, by any of a variety of methods such as brushing, rolling, spraying, curtain coating, or other application method, including aerosol spray from a sealed and pressurized container. Many conventional paint compositions, and particularly aerosol paints, adhere poorly to many plastic substrates. The coatings of this invention, however, can be applied to a variety of substrates including wood, metal, and fabric and will also adhere well to many hard to coat substrates such as plastics, including polyolefins, polyphenylene oxide, PVC, BMC, SMC, polystyrene, etc. The coatings of this invention utilize a non-aqueous polymer obtained by the graft copolymerization of a halogenated, normally chlorinated, polyolefin and unsaturated monomers.

For many of the coatings within this invention it is useful to prepare a graft copolymer incorporating the chlorinated polyolefin (CPO) at a level of about 15% or less and sometimes about 10% or less of the total weight solids of the graft copolymer.

In one aspect, this invention relates to a polymer comprising the reaction product obtained by graft copolymerizing from about 1 to about 20% by weight of an unsaturated acid or anhydride and from about 61 to about 98 percent by weight of at least one other unsaturated monomer copolymerizable with the acid or anhydride with about 1 to about 19% by weight of at least one chlorinated polyolefin, wherein the percentages are based upon the total combined weight of the chlorinated polyolefin and all unsaturated monomers.

In another aspect, this invention relates to a polymer comprising the graft polymerization reaction product of:
(i) from about 1 to about 19% by weight of at least one chlorinated polyolefin;
(ii) from about 1 to about 20% by weight of an unsaturated acid or anhydride;
(iii) from about 1 to about 40%, and sometimes 10 to about 40%, styrene;
(iv) from about 21 to 97% by weight of at least one other unsaturated monomer copolymerizable with the unsaturated acid or anhydride;
   wherein the percentages are based upon the total combined weight of the chlorinated polyolefin and all unsaturated monomers.

Another aspect involves non-aqueous coatings that utilize these polymers. Further aspects, features, and advantages of the present invention will become better understood with regard to the following description, examples, appended claims and accompanying drawing.

### DESCRIPTION OF THE DRAWINGS

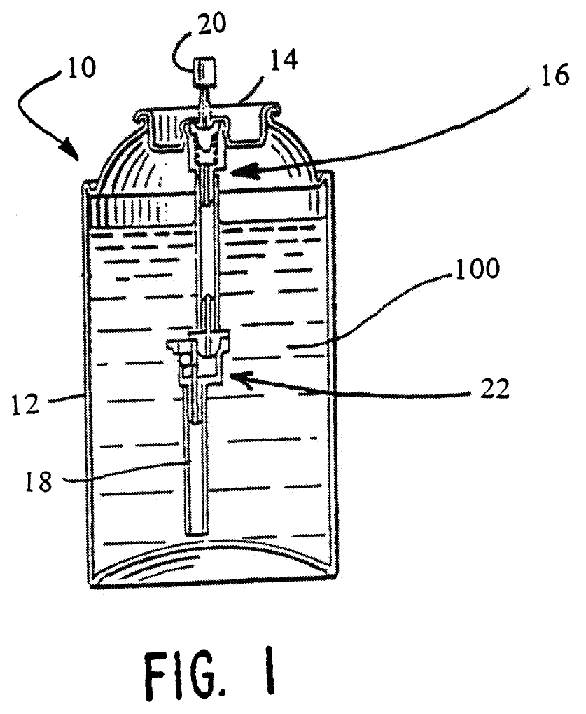

One method of applying the coatings of this invention is by aerosol spray. FIG. 1 shows a schematic of a representative aerosol container charged with an aerosol paint composition prepared in accordance with this invention. In preparing an aerosol paint composition, the coating of this invention is added to a container, such as container 10 shown in FIG. 1, and then the propellant is added to form the aerosol paint composition.

Referring now to FIG. 1, the container 10 comprises a can 12, to which a valve cup 14 is secured. A valve assembly 16 with a dip tube 18 connected thereto is secured to the valve cup 14. The dip tube 18 extends into the interior of the can 12 and is in contact with the aerosol paint composition, which is designated by the numeral 100. The can 12 may typically be composed of aluminum or tin plated steel. If desired the can may be lined or coated to minimize corrosion while in contact with the coatings. The valve cup 14 may be sealed to the can 12 and the propellant charged through the valve assembly 16, or the can 12 may be charged with the propellant under the valve cup 14, and then the valve cup 14 sealed to the can 12. An actuator 20 is then connected to the valve assembly 16.

Various valves, dip tubes and actuators may be used to spray the aerosol paint composition. For many applications, the dip tube 18 is a standard dip tube having a diameter of about 0.147 inches. The valve assembly 16 may be either a “female” aerosol valve or a “male” aerosol valve. Examples of “female” aerosol valves that may be used in the present invention are disclosed in U.S. Pat. Nos. 3,033,473; 3,061,203; 3,074,601; 3,209,960; and 5,027,985. Examples of “male” aerosol valves that may be used in the present invention are disclosed in U.S. Pat. Nos. 2,631,814, and 4,572,406. For some applications, the valve assembly 16 is a “female” valve with a spray controller 22 having a construction as disclosed in U.S. Pat. No. 4,572,406, which is hereby incorporated by reference. The spray controller 22 permits the aerosol paint composition 100 to be dispensed when the container 10 is inverted.

### Non-Aqueous Coating Compositions and Components

### 1. Graft Copolymers of Unsaturated Monomers with Chlorinated Polyolefins

The polymers of this invention are conveniently obtained by the graft polymerization of an unsaturated acid or anhydride and at least one other unsaturated monomer copolymerizable with the unsaturated acid or anhydride onto at least one halogenated polyolefin, such as a chlorinated polyolefin.

Chlorinated polyolefins (CPOs) are well known in the art and include, representatively, chlorinated polypropylene, chlorinated polybutene, chlorinated polyethylene etc. The CPOs can be prepared by any method known in the art. For example, the CPO can be prepared by dissolving the polyolefin in a suitable solvent and then blowing chlorine gas into the solution, usually in the presence of a radical catalyst. Typically, for many commercial products, chlorination levels of at least about 10% by weight, and frequently 15 to about 50% by weight are achieved. The CPOs can also have some acid functionality, generally incorporated by reaction of an acid or anhydride onto the polyolefin. For some applications of this invention, it can be useful to utilize CPOs having a number average molecular weight less than about 50,000. In other applications, it can be useful to utilize a CPO having a number average molecular weight less than about 30,000. Number average molecular weight is typically determined relative to a polystyrene standard.

The graft copolymers useful in this invention are conveniently prepared by admixing the ethylenically unsaturated monomers and CPO in the presence of a polymerization initiator such as t-butyl peroxybenzoate, benzoyl peroxide, di-tert-butyl peroxide and/or azobisisobutyronitrile.

Suitable monomers for copolymerization with the CPO include (meth)acrylic monomers and vinyl aromatic monomers. Representative vinyl aromatic monomers include styrene, alpha methyl styrene or other lower alkyl styrene, chlorostyrene, vinyl toluene, vinyl naphthalene, and divinyl benzene. For some applications of this invention, it is useful to provide at least 1% and sometimes at least 10%, and sometimes between 10 and 40%, of the total amount of CPO and copolymerizable monomer as a vinyl aromatic monomer such as styrene.

Representative copolymerizable acrylic monomers include any compounds having acrylic functionality, such as alkyl (meth)acrylates, (meth)acrylic acids, acrylamides and acrylonitrile. Typically, the alkyl (meth)acrylate monomers (commonly referred to as “alkyl esters of (meth)acrylic acid”) will have an alkyl ester portion containing from 1 to about 12, and generally about 1 to 8, carbon atoms per molecule. Suitable alkyl (meth)acrylate monomers include, for example, methyl (meth)acrylate, ethyl (meth)acrylate, butyl (meth)acrylate, propyl (meth)acrylate, 2-ethyl hexyl (meth)acrylate, cyclohexyl (meth)acrylate, decyl (meth)acrylate, isodecyl (meth)acrylate, benzyl (meth)acrylate, isobornyl (meth)acrylate, neopentyl (meth)acrylate, 1-adamatyl methacrylate and various reaction products such as butyl, phenyl, and cresyl glycidyl ethers reacted with (meth)acrylic acid, hydroxyl alkyl (meth)acrylates, such as hydroxyethyl and hydroxypropyl (meth)acrylates, and amino (meth)acrylates. The term “(meth)acrylate” is meant to include acrylates and methacrylates. Other copolymerizable unsaturated monomers, including vinyl compounds such as vinyl acetate, or vinyl versatate can also be utilized. Monomers capable of latent crosslinking such as diacetone acrylamide can also be used.

Suitable unsaturated acids and anhydrides which could be copolymerized into the graft copolymers include the unsaturated derivatives of inorganic acids such as AMPS (acrylimidomethylpropane sulfonic acid, available from Lubrizol), and phosphoric acid derivatives such as hydroxy ethyl methacrylate phosphate or the phosphate ester of 3-hydroxy propyl methacrylate, as well as unsaturated organic acids such as (meth)acrylic acid, ethacrylic acid, alpha-chloroacrylic acid, alpha-cyanoacrylic acid, crotonic acid, beta-acryloxy propionic acid, beta-styryl acrylic acid, maleic anhydride, and the unsaturated acids and anhydrides taught in U.S. Pat. Nos. 5,863,998, 5,633,327, 5,444,122, and 5,405,973, the teachings of which are hereby incorporated by reference. For some applications it is useful to provide a final acid value of at least about 10, or for some applications at least about 20, or, for some applications, at least about 40, or, for some applications, at least about 60 for the graft copolymer. Since the coatings of this invention are intended to be non-aqueous, organic solvent borne coatings, typically it is not necessary to neutralize the acid functionality with a base to ensure solubility.

The CPO based graft copolymers can be conveniently prepared by admixing the monomers and the CPO in the presence of a suitable initiator under suitable graft copolymerization conditions. It is frequently useful to incorporate the CPO into the reaction mixture as a solution in a suitable solvent such as toluene or xylene. The reaction temperatures will typically be at least about 240° F., and may range up to about 350° F. It is often useful to gradually admix the reactants into a heated solvent solution. For some production of the graft copolymer, it can be useful to prepare a premix of a solvent solution of the CPO and some, or all, of any unsaturated vinyl aromatic monomers to ensure solubility of the CPO and to minimize any requirement for solvent in the reaction mixture. Additionally, for some embodiments of this invention it is desirable to minimize the level of CPO in the final graft copolymer to minimize final viscosity and reduce the requirement for additional solvents. For many formulations, it can be useful to incorporate the CPO at a level of 1 to about 15%, 1 to about 10%, 1 to about 6%, or even 1 to about 4%, of the total combined weight of the chlorinated polyolefin and all copolymerizable monomers in the graft copolymer.

The graft copolymers of this invention are useful in a variety of applications, including their use as components of coating compositions. The paint compositions of the present invention may include other optional ingredients, such as other solvent-miscible polymers, crosslinkers, pigments, surfactants and dispersants, rheology modifiers, anti-skinning agents, drying agents, light stabilizers and ultraviolet light absorbers, and solvents. It is intended that the paint compositions of this invention be non-aqueous.

### 2. Additional Film-Forming Polymers

If desired, other non-aqueous film forming polymers such as solvent borne acrylics, polyesters (including alkyds), and polyurethanes can optionally be combined with the graft copolymers in coating formulations. Non-aqueous dispersions (NAD's) of polymers can also be utilized. Typically, these additional polymers, if incorporated, may be present at a level of about 1 to about 99% by weight solids of the combined weight of the graft copolymer and the additional polymer. For some applications it is useful to incorporate the additional film forming polymers at a level from about 10 to about 80 and sometimes from about 10 to about 60% by weight solids of the combined weight of the additional solvent borne film-forming polymer and the graft copolymer into the coating.

For some applications of this invention it is useful to incorporate alkyds as an additional non-aqueous film forming polymer. Alkyds, and their method of production, are well known in the art. The alkyds can be conventional alkyds such as those formed from the reaction of dihydric or polyhydric alcohols and at least one polybasic acid or anhydride, along with a fatty acid modifier such as a fatty acid or fatty oil. Representative polyhydric alcohols include pentaerythritol, glycerol, propylene glycol, ethylene glycol, sorbitol, trimethylolethane, trimethylolpropane, dipentaerythritol, tripentaerythritol, neopentyl glycol, diethylene glycol, hexanetriol. Representative polybasic acids and anhydrides include phthalic anhydride, maleic anhydride, fumaric anhydride, adipic acid, azelaic acid, sebacic acid, tetrachlorophthalic anhydride, chlorendic anhydride, dimerized fatty acids, trimellitic anhydride and succinic anhydride. Representative fatty acids and oils include drying oils and semi drying oils such as soya oil, dehydrated castor oil, linseed oil, perilla oil, cottonseed oil, tall oil, safflower oil, fish oil and tung oil, and non-drying oils such as coconut oil, castor oil, palm oil and peanut oil, and the fatty acids derived from these oils. Preferably, the fatty acid modifier is derived from a drying oil or a semi drying oil.

Other useful alkyds include acrylic modified alkyd resins which are comprised of an acrylic portion and an alkyd portion. In the acrylic modified alkyd resins, the acrylic portion is formed from monomers comprising at least one (meth)acrylic monomer and can be a homopolymer or a copolymer. For some applications, the acrylic portion is a copolymer formed from at least one (meth)acrylic monomer and a vinyl aromatic hydrocarbon, such as styrene, a methyl styrene or other lower alkyl styrene, chlorostyrene, vinyl toluene, vinyl naphthalene, or divinyl benzene. Suitable (meth)acrylic monomers include any compounds having acrylic functionality such as those discussed above for use in the CPO graft copolymer.

The alkyd portion of the acrylic modified alkyd resin may be formed by any of the traditional processes, such as: (i.) the direct esterification of a drying oil fatty acid with a di- or polycarboxylic acid and a polyhydric alcohol, (ii.) the indirect esterification of a drying oil by first alcoholization with a polyhydric alcohol and second esterification with a polybasic acid, or a (iii.) two-step process wherein the first step comprises the acidolysis reaction of a triglyceride oil with a trifunctional carboxylic acid or a trifunctional anhydride, and the second step comprises reacting the product of the first step with a multifunctional alcohol, as is disclosed in U.S. Pat. No. 4,983,716, which is hereby incorporated by reference.

Typical raw materials for the formation of alkyds include triglyceride oils or the fatty acids thereof. These can be selected from the group consisting of linseed oil, soya oil, coconut oil, cottonseed oil, peanut oil, canola oil, corn oil, safflower oil, sunflower oil, dehydrated castor oil, fish oil, perilla, lard, walnut oil, tung oil, tall oil, the fatty acids thereof and mixtures thereof. Particularly preferred are those oils and acids containing unsaturation in the glyceride chains. Particularly preferred are soya oil, dehydrated castor oil and linseed oil and the fatty acids thereof.

Multi-functional alcohols, and mixtures thereof, are also common raw materials for the production of alkyds. One suitable hexafunctional alcohol includes dipentaerythritol. One suitable tetrafunctional alcohol includes pentaerythritol. Suitable trifunctional alcohols include the group consisting of trimethylol propane, trimethylol ethane, glycerine, tris hydroxyethyl isocyanurate, and mixtures thereof, either alone or in combination with a difunctional alcohol such as ethylene glycol, propylene glycol, cyclohexane dimethanol, and mixtures thereof. Additionally, dimethylol propionic acid can be used in combination with the trifunctional alcohol.

Another typical raw material used in the formation of alkyds are the multi-functional carboxylic acids or anhydrides. Suitable trifunctional carboxylic acids include trimelletic acid, trimesic acid, 1,3,5-pentane tricarboxylic acid, citric acid and others whereas suitable trifunctional anhydrides include trimelletic anhydride, pyromelletic anhydride and others. Difunctional carboxylic acids include phthalic acid, isophthalic acid, terephthalic acid, maleic acid and fumaric acid and mixtures thereof. Mixtures of such acids and anhydrides are also acceptable.

The acrylic modified alkyd resin may be formed by contacting and reacting, under free radical polymerization conditions, the acrylic portion monomers with either the pre-formed alkyd resin or, alternatively, with the alkyd resin precursors during the formation of the alkyd resin. The acrylic modified alkyd resin may also be formed by other methods, such as first forming the acrylic portion so as to have pendant carboxy substituents (and optionally hydroxy substituents) and then reacting this polymer with a mixture of alkyd resin components or precursors, i.e., a polycarboxylic acid (or, alternatively, the corresponding anhydride), a polyhydric alcohol, and a fatty acid (or, alternatively, the corresponding triglyceride or fatty acid oil), as is disclosed in U.S. Pat. No. 4,010,126, which is hereby incorporated by reference.

A commercially available acrylic modified alkyd resin that may be used in the aerosol paint composition is POLYCHEM 7060-V-60 sold by OPC Polymers of Columbus, Ohio. POLYCHEM 7060-V-60 is an acrylic-vinyl toluene alkyd resin formed from soya oil.

As used herein, the term “film-forming polymer” means that the polymer can form a continuous film upon evaporation of all solvent or carrier and/or upon cure of the polymer.

For some applications the paint compositions of this invention can optionally incorporate a crosslinking agent reactive with any functional groups pendent on the graft copolymer. For example, if the graft copolymer incorporates pendent hydoxyl groups, crosslinkers such as ureas, melamines, or isocyanates could be utilized. Graft copolymers having pendent acid groups could be used in combination with polyepoxides as crosslinkers. Graft copolymers incorporating diacetone acrylamide could be crosslinked with reactive materials such as adipic dihydrazide. If crosslinkers are incorporated, catalysts for the curing reaction may also be incorporated as is well known in the art. For some crosslinking reactions, such as melamine/hydroxyl reactions, it is typically necessary to cure the coating at elevated temperatures ranging up to about 400° F.

The coating compositions of this invention may also incorporate at least one pigment. Representative pigments include, for example, titanium dioxide, carbon black, graphite, ceramic black, lamp black, antimony sulfide, black iron oxide, aluminum pastes, yellow iron oxide, red iron oxide, iron blue, phthalo blue and green, nickel titanate, dianisidine orange, dinitroaniline orange, imidazole orange, quinacridone red, violet and magenta, toluidine red, molybdate orange, and the like. Extender pigments, such as amorphous, diatomaceous, fumed, quartz and crystalline silica, clays, aluminum silicates, magnesium aluminum silicates talc, mica, delaminated clays, calcium carbonates and silicates, gypsum, barium sulfate, calcium zinc molybdates, zinc oxide, phosphosilicates and borosilicates of calcium, barium and strontium, barium metaborate monohydrate, and the like can also be incorporated.

Suitable rheology modifiers which optionally can be included in the coatings of this invention representatively include organoclays, fumed silica, dehydrated castor oil organic derivatives, English China Clay; polyamides, polyamide modified alkyds, alkylbenzene sulphonate derivatives, aluminum, calcium and zinc stearates, calcium soyate, associative thickeners and the like. Suitable solvents for coatings of this invention include solvents which are stabily miscible with the coatings and representatively include, alcohols, ketones, ethers, esters, glycol ethers, glycol ether esters, aliphatic and aromatic hydrocarbons, etc.

### Aerosol Paint Compositions

In those instances when it is desired to utilize the coating compositions of this invention as aerosol coating compositions, the aerosol paint composition can be conveniently prepared by combining the solvent borne coating composition (described above) with, if desired additional organic solvents, and incorporating a propellant which can aerosolize the combination.

The propellant is a liquefiable gas having a vapor pressure sufficient to propel the aerosol paint composition from the container. In many cases, the propellant is selected from the group consisting of ethers, saturated hydrocarbons, hydrofluorocarbons (HFC), and mixtures thereof. Representative propellants include dimethyl ether (DME) and diethyl ether; methane, ethane, propane, n-butane, and isobutane; 1,1,1,2-tetrafluoroethane (HFC-134a), 1,1,1,2,3,3,3,-heptafluoropropane (HFC-227), difluoromethane (HFC-32), 1,1,1-trifluoroethane (HFC-143a), 1,1,2,2-tetrafluoroethane (HFC-134), and 1,1-difluoroethane (HFC-152a). For some applications, a blend of n-butane and propane is a useful propellant.

The amount of the propellant present in the aerosol paint composition is typically at least 10 weight percent and frequently from about 10 to about 40 weight percent, and for some applications from about 15 to about 25 weight percent of the total weight of the aerosol paint composition. When the propellant is present in an amount of from about 15 to about 25 weight percent, an initial pressure of typically between about 40 pounds per square inch and 70 pounds per square inch is obtained in the container.

The amount of organic solvent present in the aerosol paint composition is typically at least 30 weight percent of the total weight of the aerosol paint composition. For many applications, the, the amount of organic solvent present in the aerosol paint composition will range from about 30 to about 60 weight percent, and for some applications from about 45 to about 55 weight percent of the total weight of the aerosol paint composition.

The amount of polymer resins, including the graft copolymer of the CPO and the additional film-forming resins, if any, present in the aerosol paint composition is typically at least 10 weight percent of the total weight of the aerosol paint composition. For many applications, the amount of polymer resins present in the aerosol paint composition is from about 10 to about 30 weight percent, and for many applications will range from about 15 to about 25 weight percent of the total weight of the aerosol paint composition.

The present invention will be better understood by reference to the following examples which are provided for purposes of illustration only and are not to be construed as limiting the scope of the present invention. As used herein, unless otherwise indicated, “parts” are “parts by weight”.

### RESIN EXAMPLE 1

A reaction vessel equipped with a nitrogen purge, stirrer, and two raw material inlets was charged with 108.8 parts PnB Glycol Ether (propylene glycol mono-n-butyl ether manufactured by The Dow Chemical Company) and heated to 280° F. and purged with nitrogen. Two separate raw material mixtures, mixture A and mixture B, were prepared.

### Mixture A

| Raw materials | Parts by Weight |
|---|---|
| methacrylic acid | 102.4 |
| methyl methacrylate | 190.0 |
| 2-ethyl hexyl acrylate | 355.5 |
| t-butyl peroxybenzoate | 22.6 |
| dodecyl mercaptan | 19.0 |

### Mixture B

| Raw materials | Parts by Weight |
|---|---|
| styrene | 270.5 |
| chlorinated polyolefin¹ | 270.5 |

¹50% by weight chlorinated polyolefin in xylene - having 26-32 weight percent chlorine and a number average molecular weight of approximately 24,000, commercially available from Eastman Chemical Company as Eastman CPO 343.3.

The mixtures were simultaneously added to the reaction vessel at a rate of 3.8 parts per minute for mixture A and a rate of 3.0 parts per minute for mixture B over a three hour period. The reaction mixture was then held at the 280° F. temperature for one-half hour and then, for a two hour period, a mixture of 22.6 parts t-butyl peroxybenzoate and 37.6 parts PnB Glycol Ether was added at a rate of 0.5 parts per minute over a two hour period. The reaction mixture was then held at the reaction temperature for 30

additional minutes and then allowed to cool to about 180-200° F. The polymer had an acid value of approximately 63.

### RESIN EXAMPLE 2

A reaction vessel equipped as described in Resin Example 1 was charged with 117.5 parts PnB Glycol Ether and heated to 280° F. and purged with nitrogen. Two separate raw material mixtures, mixture A and mixture B, were prepared.

### Mixture A

| Raw materials | Parts by weight |
|---|---|
| methacrylic acid | 110.6 |
| methyl methacrylate | 205.2 |
| 2-ethyl hexyl acrylate | 384.0 |
| t-butyl peroxybenzoate | 24.5 |
| dodecyl mercaptan | 10.3 |

### Mixture B

| Raw materials | Parts by weight |
|---|---|
| styrene | 292.2 |
| chlorinated polyolefin (CPO 343.3) | 73.1 |

The mixtures were simultaneously added to the reaction vessel at a rate of 4.5 parts per minute for Mixture A and 2.0 parts per minute for Mixture B over a three-hour period. The reaction mixture was then held at the 280° F. temperature for one-half hour and then, for a two hour period, a mixture of 24.5 parts t-butyl peroxybenzoate and 40.7 parts PnB was added at a rate of 0.55 parts per minute over a two hour period. The reaction mixture was then held at 280° F. for thirty additional minutes and then allowed to cool. The copolymer had an acid value of approximately 63.

### RESIN EXAMPLE 3

A reaction vessel equipped as described in Resin Example 1 was charged with 263.8 parts PnP Glycol Ether (propylene glycol n-propyl ether from Dow Chemical) and heated to 280° F. and purged with nitrogen. Two separate raw material mixtures, mixture A and mixture B, were prepared.

### Mixture A

| Raw materials | Parts by weight |
|---|---|
| methacrylic acid | 248.2 |
| methyl methacrylate | 460.5 |
| 2-ethyl hexyl acrylate | 861.7 |
| t-butyl peroxybenzoate | 55.0 |
| dodecyl mercaptan | 23.1 |

### Mixture B

| Raw materials | Parts by weight |
|---|---|
| styrene | 655.6 |
| chlorinated polyolefin (CPO 343.3) | 494.7 |

The mixtures were simultaneously added to the reaction vessel at a rate of 9.2 parts per minute for Mixture A and 6.3 parts per minute for Mixture B over a three-hour period. The reaction mixture was then held at the 280° F. temperature for one-half hour and then, for a two hour period, a mixture of 55.0 parts t-butyl peroxybenzoate and 91.3 parts PnB was added at a rate of 0.55 parts per minute over a two hour period. The reaction mixture was then held at 280° F. for thirty additional minutes and then allowed to cool.

### RESIN EXAMPLE 4

A reaction vessel equipped as described in Resin Example 1 was charged with 290.2 parts Butyl Cellosolve® (2-butoxyethanol) and heated to 280° F. and purged with nitrogen. Two separate raw material mixtures, mixture A and mixture B, were prepared.

### Mixture A

| Raw materials | Parts by weight |
|---|---|
| methacrylic acid | 273.0 |
| methyl methacrylate | 601.3 |
| 2-ethyl hexyl acrylate | 853.0 |
| t-butyl peroxybenzoate | 60.5 |
| dodecyl mercaptan | 25.4 |

### Mixture B

| Raw materials | Parts by weight |
|---|---|
| styrene | 721.2 |
| chlorinated polyolefin (CPO 343.3) | 543.8 |

The mixtures were simultaneously added to the reaction vessel at a rate of 10.1 parts per minute for Mixture A and 7.1 parts per minute for Mixture B over a three-hour period. The reaction mixture was then held at the 280° F. temperature for one-half hour and then, for a two hour period, a mixture of 60.5 parts t-butyl peroxybenzoate and 100.4 parts Butyl Cellosolve was added at a rate of 1.34 parts per minute over a two hour period. The reaction mixture was then held at 280° F. for thirty additional minutes and then allowed to cool to about 170° F. and then 1500 parts of the reaction mixture was admixed with 530 parts of xylene. The final copolymer product had an NVM of approximately 62.2% and a weight per gallon of about 8.27 lbs./gal.

### PAINT EXAMPLE 1

A representative gloss black formulation of the inventive solvent-borne paint composition was prepared by admixing the following raw materials in appropriate dispersing equipment. Parts are parts by weight.

| | | | |
|---|---|---|---|
| (a) | Toluene | 183.73 | parts |
| (b) | POLYCHEM 7060-V-60 | 844.88 | parts |
| (c) | Organoclay (Bentone 34) | 38.87 | parts |
| (d) | Methanol | 12.73 | parts |
| (e) | SUSPENO ® 201-T | 22.17 | parts |
| (f) | DYSPERBYK ®-163 | 22.21 | parts |
| (g) | BYK P104-S | 22.17 | parts |
| (h) | carbon black pigment | 126.26 | parts |
| (i) | toluene | 223.96 | parts |
| (j) | POLYCHEM 7060-V-60 | 2070.43 | parts |
| (k) | toluene | 182.76 | parts |
| (l) | Resin Example 4 | 1166.23 | parts |
| (m.) | toluene | 210.46 | parts |
| (n) | 2-butoxy ethanol | 576.76 | parts |
| (o) | methyl isobutyl ketone | 444.32 | parts |
| (p) | n-butyl alcohol | 104.64 | parts |
| (q) | acetone | 252.94 | parts |
| (r) | xylene | 391.99 | parts |
| (s) | TINUVIN ® 292 | 16.80 | parts |
| (t) | TINUVIN ® 328 | 16.80 | parts |
| (u) | Methyl Ethyl Ketoxime | 10.35 | parts |
| (v) | 12% cobalt drier | 3.11 | parts |
| (w) | 12% Manganese Carboxylate | 2.07 | parts |
| (x.) | Silicon anti-flooding solution | 5.18 | parts |
| (y) | POLYCHEM 7060-V-60 | 378.68 | parts |
| (z) | toluene | 143.10 | parts |

Where:
(a) POLYCHEM 7060-V-60 is an acrylic/vinyl toluene modified alkyd available from Ohio Polychem.
(e) SUSPENO® 201-T is an organic anti-settling, anti-sag rheological additive available from Poly-Resyn, Inc., located in Dundee, Ill. 60118.
(f) DYSPERBYK®-163 is a high molecular weight block copolymer with pigment affinic groups that is used for wetting and dispersing pigments and is available from BYK-Chemie USA, located in Wallingford, Conn.
(g) BYK®-P 104 S is a lower molecular weight unsaturated polycarboxylic acid polymer with a polysiloxane copolymer that is used for wetting and dispersing pigments and is available from BYK-Chemie USA, located in Wallingford, Conn.
(s) TINUVIN® 292 is a light stabilizer [bis (1,2,2,6,6-pentamethyl-4-piperidinl)sebacate] available from Ciba-Geigy.
(t) TINUVIN® 328 is a UV absorber [2-(3′,5′-di-n-pentyl-2′-hydroxyphenyl)-benzotriazole] available from Ciba-Geigy.
   An aerosol coating was prepared by charging a conventional aerosol container with 0.355 lbs. of Paint Example 1, 0.07 lbs. of toluene, 0.325 lbs. of acetone, and 0.25 lbs. of NP-85 (blend of approximately 73.7 mol % propane and 26.3 mol % n-butane).

While the invention has been shown and described with respect to particular embodiments thereof, those embodiments are for the purpose of illustration rather than limitation and other variations and modifications of the specific embodiments herein described will be apparent to those skilled in the art, all within the intended spirit and scope of the invention. Accordingly, the invention is not to be limited in scope and effect to the specific embodiments described herein, nor in any other way that is inconsistent with the extent to which the progress in the art has been advanced by the invention.

What is claimed is:

1. A non-aqueous polymer solution comprising:
(i) an organic solvent;
(ii) an acid functional polymer comprising the reaction product of:
(a) from about 1 to about 19% by weight of at least one chlorinated polyolefin;
(b) from about 1 to about 20% by weight of an unsaturated acid or anhydride;
(c) from about 61 to about 98% by weight of at least one other unsaturated monomer copolymerizable with the unsaturated acid or anhydride;
wherein the percentages are based upon the total combined weight of the chlorinated polyolefin (a) and all unsaturated monomers (b) and (c).

2. The polymer solution of claim 1 wherein the acid functional polymer comprises the reaction product of:
(a) from about 1 to about 19% by weight of at least one chlorinated polyolefin;
(b) from about 1 to about 20% by weight of an unsaturated acid or anhydride;
(c) from 1 to about 40% styrene;
(d) from about 21 to about 97% by weight of at least one other unsaturated monomer copolymerizable with the unsaturated acid or anhydride;
wherein the percentages are based upon the total combined weight of the chlorinated polyolefin and all unsaturated monomers.

3. The polymer solution of claim 1 wherein the acid functional polymer has an acid value of at least about 20.

4. The polymer solution of claim 1 wherein the acid functional polymer has an acid value of at least about 40.

5. The polymer solution of claim 1 wherein the acid functional polymer has an acid value of at least about 60.

6. The polymer solution of claim 2 wherein the acid functional polymer has an acid value of at least about 20.

7. The polymer solution of claim 2 wherein the acid functional polymer has an acid value of at least about 40.

8. The polymer solution of claim 2 wherein the acid functional polymer has an acid value of at least about 60.

9. The polymer solution of claim 1 wherein the chlorinated polyolefin is present at a level of about 1 to about 10% based upon the total combined weight of the chlorinated polyolefin and all unsaturated monomers.

10. The polymer solution of claim 1 wherein the chlorinated polyolefin is present at a level of about 1 to about 6% based upon the total combined weight of the chlorinated polyolefin and all unsaturated monomers.

11. The polymer solution of claim 1 wherein the chlorinated polyolefin is present at a level of about 1 to about 4% based upon the total combined weight of the chlorinated polyolefin and all unsaturated monomers.

12. The polymer solution of claim 1 wherein the chlorinated polyolefin has a number average molecular weight less than about 50,000.

13. The polymer solution of claim 1 wherein the chlorinated polyolefin has a number average molecular weight less than about 30,000.

14. The polymer solution of claim 1 wherein the polymer solution comprises an additional film-forming polymer.

15. The polymer solution of claim 14 wherein the additional polymer is selected from the group consisting of non-aqueous acrylics, polyesters, alkyds, and polyurethanes.

16. The polymer solution of claim 14 wherein the additional polymer is present at a level of about 1 to about 99% by weight of the combined weight of the graft copolymer and the additional polymer.

17. The polymer solution of claim 14 wherein the additional polymer is present at a level of about 10 to about 60% by weight of the combined weight of the graft copolymer and the additional polymer.

18. A non-aqueous coating composition comprising:
(i) at least one pigment
(ii) an acid functional polymer comprising the reaction product of:
(a) from about 1 to about 19% by weight of at least one chlorinated polyolefin;
(b) from about 1 to about 20% by weight of an unsaturated acid or anhydride;
(c) from about 61 to about 98% by weight of at least one other unsaturated monomer copolymerizable with the unsaturated acid or anhydride;
wherein the percentages are based upon the total combined weight of the chlorinated polyolefin and all unsaturated monomers; and
(iii) organic solvent.

19. The coating of claim 18 wherein the coating also comprises at least one additional non-aqueous polymer.

20. The coating of claim 19 wherein the additional polymer is an alkyd resin.

21. The coating of claim 18 wherein the acid functional polymer has an acid value of at least 20.

22. The coating of claim 18 wherein the coating comprises a crosslinking agent reactive with the acid functional polymer.

23. A substrate coated with the coating of claim 18.

24. The coated substrate of claim 23 wherein the substrate is a plastic.

25. An aerosol paint product comprising:
(i) a container comprising a can, a valve cup with a valve assembly, a dip tube and an actuator; and
(ii) a non-aqueous aerosol paint composition disposed within said container, said aerosol paint composition comprising:
(a) at least 30 weight percent solvent;
(b) at least 10 weight percent of a solvent borne coating composition;
(c) at least 10 weight percent of an aerosol propellant;
wherein the coating composition comprises:
(i) an acid functional polymer comprising the reaction product of:
(a) from about 1 to about 19% by weight of at least one chlorinated polyolefin;
(b) from about 1 to about 20% by weight of an unsaturated acid or anhydride; and
(c) from about 61 to about 98% by weight of at least one other unsaturated monomer copolymerizable with the unsaturated acid or anhydride;
wherein the percentages are based upon the total combined weight of the chlorinated polyolefin and all unsaturated monomers; and
(ii) a solvent.

26. The aerosol paint product of claim 25 wherein the non-aqueous coating composition also comprises at least one pigment.

27. The aerosol paint product of claim 25 wherein the propellant comprises dimethyl ether.

28. The aerosol paint product of claim 25 wherein the acid functional polymer comprises the reaction product of:
(a) from about 1 to about 19% by weight of at least one chlorinated polyolefin;
(b) from about 1 to about 20% by weight of an unsaturated acid or anhydride;
(c) from 1 to about 40% styrene;
(d) from about 21 to about 97% by weight of at least one other unsaturated monomer copolymerizable with the unsaturated acid or anhydride;
wherein the percentages are based upon the total combined weight of the chlorinated polyolefin and all unsaturated monomers.

29. A process of coating a substrate, which process comprises:
(i) providing an aerosol paint product comprising:
(a) a container comprising a can, a valve cup with a valve assembly, a dip tube and an actuator; and
(b) an aerosol paint composition disposed within said container, said aerosol paint composition comprising:
solvent;
a non-aqueous coating composition;
an aerosol propellant;
(ii) activating the valve assembly to create an aerosol spray of the aerosol paint composition;
(iii) directing the spray to apply the paint composition onto the substrate; and
(iv) allowing the paint composition to sure or dry; and wherein the non-aqueous coating composition comprises:
(i) an acid functional polymer comprising the reaction product of;
(a) from about 1 to about 19% by weight of at least one chlorinated polyolefin;
(b) from about 1 to about 20% by weight of an unsaturated acid or anhydride;
(c) from about 61 to about 98% by weight of at least one other unsaturated monomer copolymerizable with the unsaturated acid or anhydride;
wherein the percentages are based upon the total combined weight of the chlorinated polyolefin (a), and all unsaturated monomers (b) and (c); and
(ii) an organic solvent.

30. The process of claim 29 wherein the substrate is plastic.
